(19) United States
(12) Patent Application Publication
(10) Pub. No.: US 2025/0391233 A1
(43) Pub. Date: Dec. 25, 2025

(54) Chip Validation and Table Drop Accounting System

(71) Applicant: California Commerce Club, Inc., Commerce, CA (US)

(72) Inventor: Lawrence Yu, Commerce, CA (US)

(73) Assignee: California Commerce Club, Inc., Commerce, CA (US)

(21) Appl. No.: 18/751,046

(22) Filed: Jun. 21, 2024

(51) Int. Cl. G07F 17/32

(52) U.S. Cl. CPC G07F 17/322

(57) ABSTRACT

A networked system of chip validation and counting assemblies associated with each table through which the chips pass prior to being captured in the chip collection box. The counting assembly incorporates components to identify the denomination of each chip or coin inserted through the drop slot. The denomination of the received chips or coins is immediately transferred over a network to the casino accounting system which then tracks the total rake for each table in real time.

### BACKGROUND OF THE INVENTION

Casinos and poker rooms incorporate colored chips with various denominations for players to wager. During game play, the dealer will periodically remove one or more chips from the pile, the casino's rake or scaled commission fee, and drop the chips through a slot in the table into a chip collection box under the table proximate the dealer. The chip collection boxes are periodically replaced at the table and taken to a count room where the casino then ascertains the revenue generated by the table. Some systems include a chip identification assembly having a mechanical arm that stops each chip as it is dropped and photographs the chip to determine the denomination before the chip is deposited in the collection box. With this system, the casino generally uses a time management system to change out the chip collection boxes, for example every four or six hours of game play. However, the casino accounting system will not obtain data on the take from any particular table until the chip box is taken to the count room. It would be beneficial to the casino to have a system to track in real time the revenue on each table on the casino floor.

### SUMMARY OF THE INVENTION

The present invention comprises a networked system of chip validation and counting assemblies associated with each table through which the chips pass prior to being captured in the chip collection box. The counting assembly incorporates components to identify the denomination of each chip or coin inserted through the drop slot. The denomination of the received chips or coins is immediately transferred over a network to the casino accounting system which then tracks the total rake for each table in real time. In one embodiment, the validation and accounting system uses a high speed camera triggered by the insertion of a chip through the slot in the table and software to view the camera image to identify the chip denomination. Alternate systems may use a radio frequency identification (RFID) technology reader to read RFID circuits embedded within the chips, or an optical reader that reads encoded information printed on the chips.

In the high speed camera embodiment, when the dealer drops chips through the slot to be collected, a high speed camera takes a series of pictures of the falling chip and software determines the denomination from the images captured by the camera. A second camera may be used to take a picture of a QR code or bar code on the chip collection box to identify the collection box and the table receiving the chip. With this information, the casino accounting system can determine the revenue per table, and thus for each dealer assigned to the table, in real time, and the casino accounting system can identify when the chip collection box for each table should be changed, to optimize efficiency and minimize disruption of game play.

### BRIEF DESCRIPTION OF THE DRAWINGS

FIG. 1 depicts a seven player gaming table with server connectivity.

FIG. 2 depicts gaming tables within a casino environment with each gaming table having server connectivity.

FIG. 3 depicts a perspective view of a chip validation assembly and collection box verification system.

FIGS. 4A, 4B and 4C depict perspective views of the chip validation assembly of FIG. 3.

FIG. 5 depicts an exploded perspective view of the chip validation assembly of FIGS. 4A, 4B and 4C.

FIG. 6 depicts an exploded perspective view of the chip camera and sensor of the chip validation assembly.

FIG. 7 depicts a perspective view of the collection box verification system of FIG. 3.

FIG. 8 depicts an exploded perspective view of the collection box verification system of FIG. 7.

FIG. 9 depicts an exploded perspective view of the table controller for the chip validation assembly and collection box verification system.

FIG. 10 depicts an exemplary flow chart tracing the information from the validation assembly and collection box verification system.

### DETAILED DESCRIPTION OF THE INVENTION

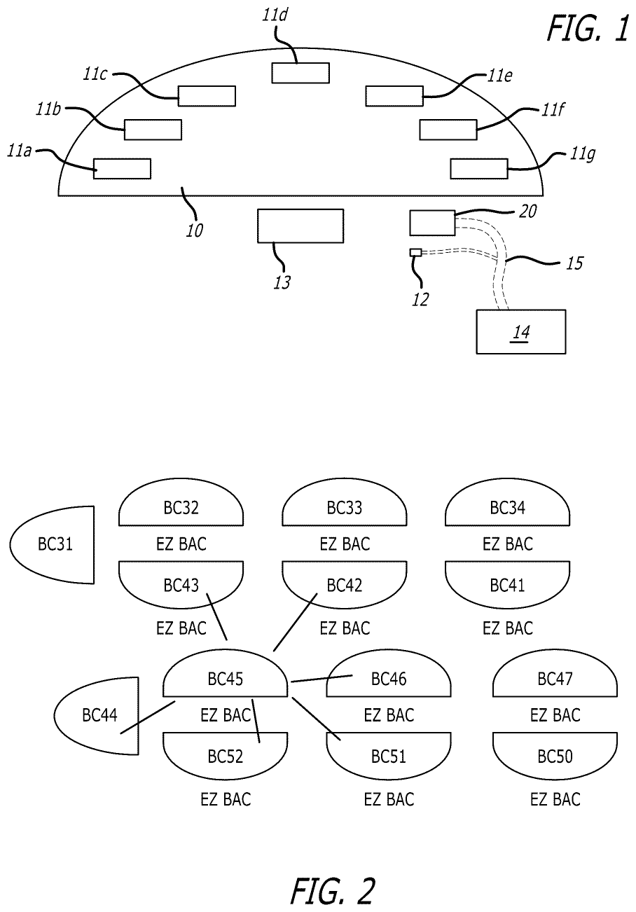

FIG. 1 provides an exemplary schematic view of a seven player gaming table 10 having player stations 11a-11g, a table controller 12 providing wired or wireless connectivity to a remote computer or casino server 14. The gaming table 10 includes a dealer station 13 and a chip validation assembly and collection box verification system 20 of the present invention located by the dealer station 13. The validation assembly and collection box verification system 20 is connected to the table controller 12 and therethrough to the casino server 14. FIG. 2 depicts a layout for a plurality of gaming tables (BC31-BC34, BC41-BC47, BC50, BC51), each connected to the casino server 14 via an ethernet, intranet, mesh network or hard wired communication system. If an individual table, for example gaming table BC45, losses connectivity to the casino server 14, the casino server 14 activates a mesh network to notify the surrounding gaming tables BC42, BC43, BC44, BC46, BC51 and BC52 that connectivity to gaming table BC45 has been lost, and query BC-45 as to why it lost normal network connectivity and/or server connectivity as a backup communication until the primary network interface is repaired. In addition, the mesh network and/or the table controllers 12 associated with those surrounding gaming tables can notify the respective dealer stations 13 that there is an issue with the connectivity to gaming table BC45. Also, the casino server 14 can flag the gaming table BC45 issue to the maintenance personnel to initiate service of the table controller 12 or chip validation assembly and collection box verification system 20 located at gaming table BC45.

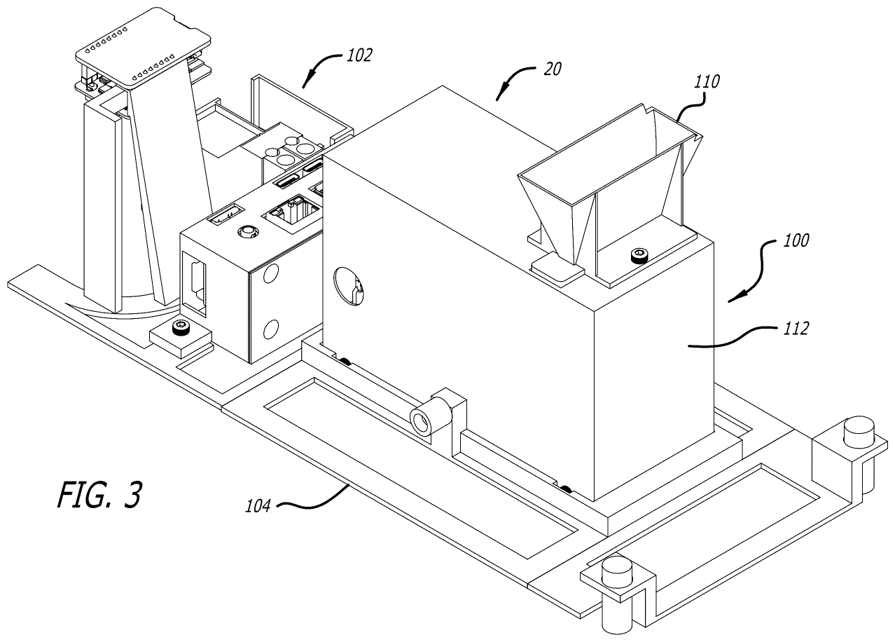

FIG. 3 depicts a perspective view of a chip validation assembly and collection box verification system 20, which comprises a chip validation assembly 100, a collection box verification system 102, both mounted on a frame 104. The chip validation assembly 100 also includes a coin chute 110 that preferably projects up through an opening in the gaming table 10 proximate the dealer station 13. As depicted in FIG. 3, the chip validation assembly 100 includes a chip validation housing 112 that may be made from sheet metal, plastic or composite materials.

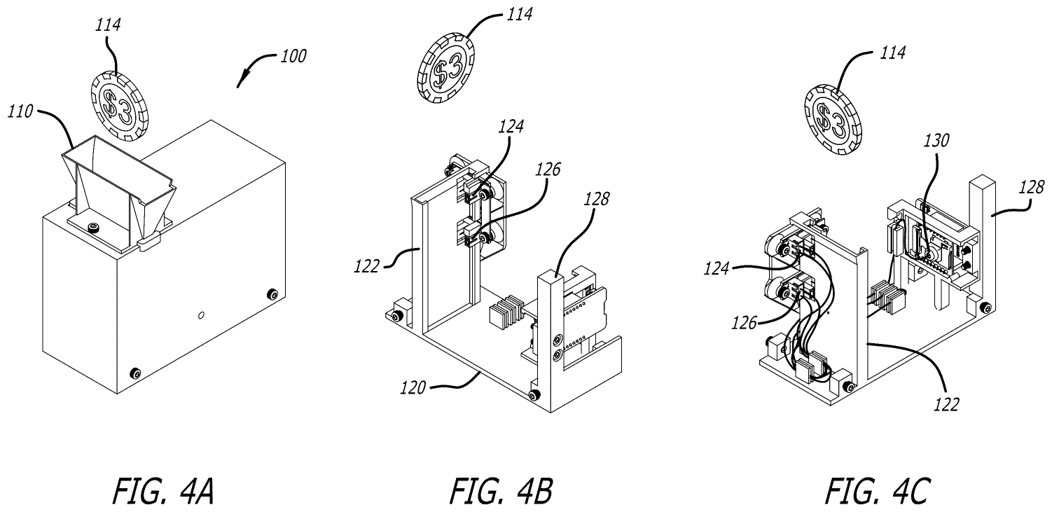

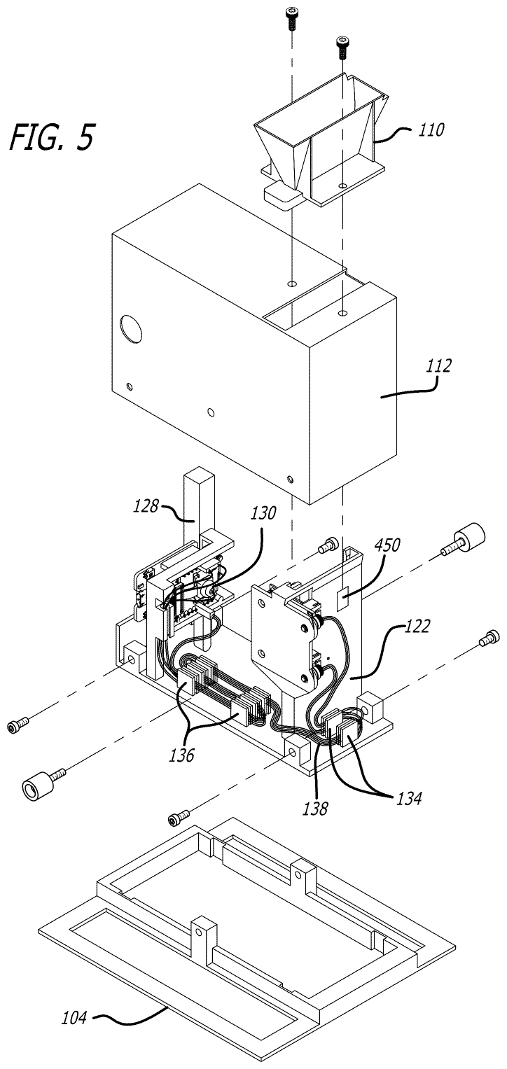

FIGS. 4A, 4B and 4C depict perspective views of the chip validation assembly 100 of FIG. 3. FIG. 4A is a perspective view of the chip validation assembly 100 including the coin chute 110 and the validation housing 112 which receives a token or chip 114. FIGS. 4B and 4C provide perspective views of the internal components of the chip validation assembly 100 contained within the validation housing 112 of FIG. 4A. FIG. 5 depicts an exploded perspective view of the chip validation assembly of FIGS. 4A, 4B and 4C.

As depicted in FIGS. 4B, 4C and 5, the components of the chip validation assembly 100 are affixed to a housing base 120 and a perpendicularly extending mounting support 122 defining the coin chute 110 through the chip validation assembly 100. The coin chute 110 preferably provides a bracket (“[”) shape with an open side facing inward that may be covered with a glass insert. An optical pre-trigger 124 and an optical trigger 126 are attached to the mounting support 122 to identify when a chip is passing through the coin chute 110. The optical pre-trigger 124 and optical trigger 126 are commonly known as an optical endstop which are available from various online suppliers. A camera support 128 attached to and extending from the housing base 120 is oppositely disposed to the mounting support 122. A validation camera 130, for example an esp32-cam camera, including a flash (not shown) is affixed to the camera support 128 facing the mounting support 128, with the field of view of the validation camera 130 focused on the open side face of the coin chute 110. When a coin or chip breaks the beam of the optical pre-trigger 124, the validation camera 130 is powered and triggered to record image frames when the coin or chip breaks the beam of the optical trigger 126. The housing base 120 also includes wire management channels 134 and 136 to mount a ribbon wiring harness 138 extending from and electrically connecting the validation camera 130 on the camera support 128 to the mounting support 122 and the optical pre-trigger 124 and optical trigger 126.

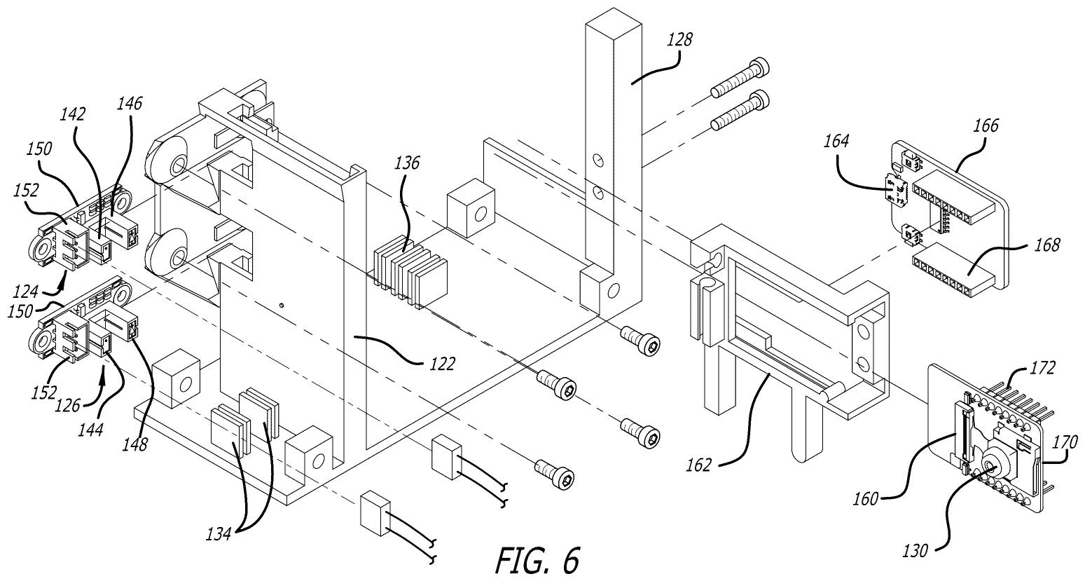

FIG. 6 depicts an exploded perspective view of the validation camera 130 and optical sensor components, the optical pre-trigger 124 and optical trigger 126 of the chip validation assembly 100 exploded from the camera support 128 and mounting support 122. Each of the optical pre-trigger 124 and optical trigger 126 include an optical emitter 142, 144 and an oppositely disposed optical receiver 146, 148 mounted on a printed circuit board 150 and a ribbon wire connector 152 to be attached to the ribbon wiring harness 138. The validation camera 130, camera processor 160 and camera board 170 are depicted exploded from a camera carrier 162 that provides the structure to attach the validation camera 130 to the camera support 128. Also depicted exploded from the camera carrier 162 is a micro USB (universal serial bus) port 164 and UART (universal asynchronous receiver-transmitter) to USB board 166 having a female pin header 168. The validation camera 130 is mounted on a camera board 170 having a plurality of male header pins 172 that connect to the female pin header 168 of the UART to USB board 166, when assembled. The camera board 160 may also include a ribbon wire connector 172 to connect to the ribbon wiring harness 138.

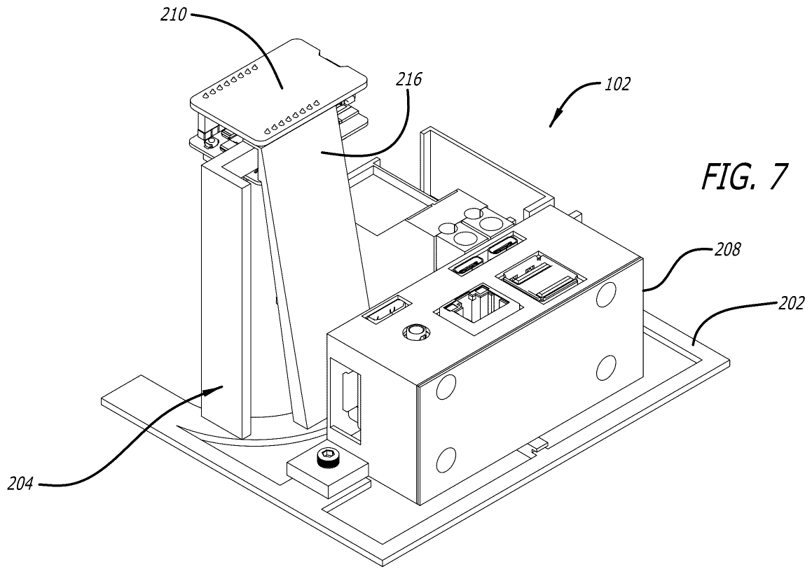

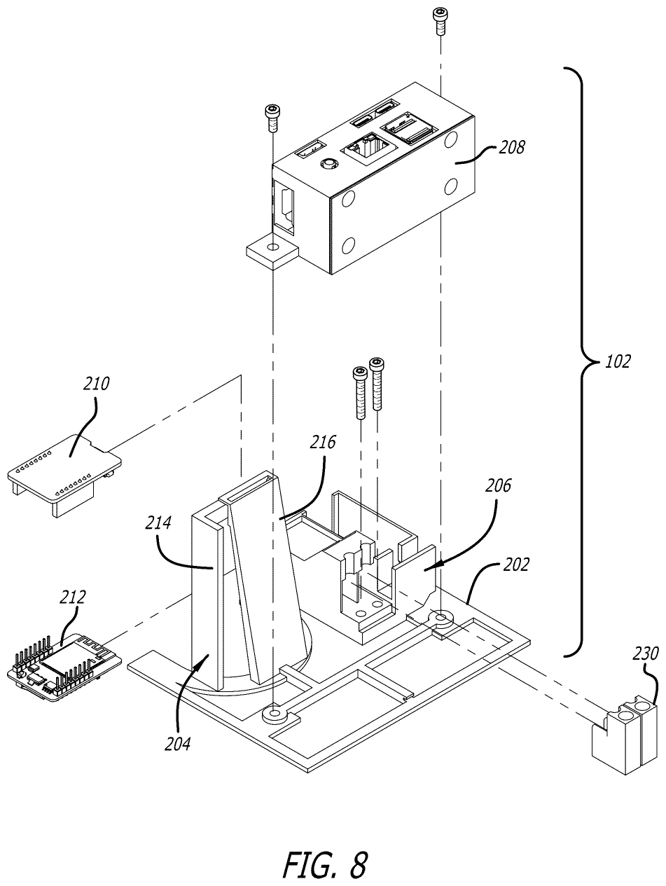

FIG. 7 depicts a perspective view of the collection box verification system 102 and FIG. 8 depicts an exploded perspective view of the collection box verification system 102. The components of the collection box verification system 102 are mounted on a base 202 including an upwardly extending camera support 204, an ethernet cable channel 206, and connections for a controller box housing 208, a UART to USB board 210, a camera board 212 and collection box camera 214 as well as a USB cable retainer 230. The collection box verification system 102 is mounted within the validation assembly and collection box verification system 20 so as to be proximate a collection box (not shown) into which the chips are directed and collected. The collection box camera 214 is positioned to have its optical field of view directed to an identification label on the outside of a collection box, so that the collection box verification system 102 can record and identify the specific collection box placed at the gaming table. The collection boxes may include a numerical identifier, a bar code, or a QR code that can be identified by the collection box camera 214, and reported to the casino server 14. Alternatively, the collection boxes may include unique patterns like paint splashes or colors, etchings, scratches or surface texturing, or a combination thereof, to uniquely identify each collection box.

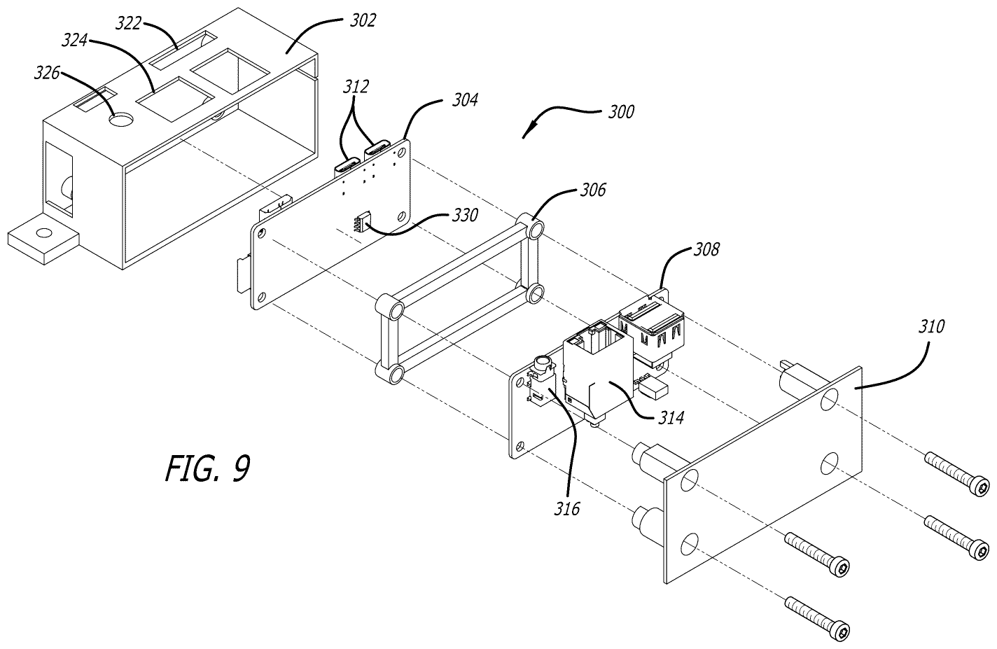

FIG. 9 depicts an exploded perspective view of the table controller 300 for the chip validation assembly 100 and collection box verification system 102. The table controller 300 is contained within the controller box housing 208 attached to the base 202 of the collection box verification system 102. The table controller 300 includes a computer board 304, a rectangular spacer 306, an expansion board 308, and a cover 310. The computer board 304 and the expansion board 308 may include one or more USB ports 312 and an ethernet port 314 as well as an audio jack 316 exposed through orifices 322, 324 and 326 respectively on the controller box housing 208. The computer board 304 includes circuitry connecting the respective components to a processor 330, commonly known as a “orange pi zero 2w” processor, which may also be used for the validation camera 130.

The above identified components of the chip validation assembly and collection box verification system 20 work together to identify each chip, coin or token inserted through the coin chute 110 as it passes through to a collection box. The system 20 allows real-time reporting of the deposit of each chip, coin or token and identifies the collection box into which each chip, coin or token is stored, to the casino server 14. The ability to identify and track in real-time the deposit of each chip, coin or token provides the casino with valuable data that may be used to enhance the gaming experience for the players as well as the revenue generation for the casino.

One issue that the chip validation assembly 100 must address results from the fact that different dealers insert or shoot a chip 14 down the coin chute 110 toward the collection box at dramatically different speeds. Some dealers just drop the chip and allow it to free fall, while others will use their fingers to rocket the chip down the coin chute 110 in order to save time. In addition, a chip drop could be 1, 2, 3 or even 4 chips or coins of a number of different denominations. Tracking a single or multiple chip drop within a limited time identifies the duration of each game, and allows the casino to monitor the speed of play as well as the amount of money being wagered per hand. The system thus allows the casino to monitor the real-time revenue of each active gaming table.

In a first embodiment, two spaced apart light sensors, the optical pre-trigger 124 and the optical trigger 126 are used to prime a flash associated with the validation camera 130, and initiate the validation camera 130 taking a sequence of image captures of the falling chip. The time between the triggering of optical pre-trigger 124 and the optical trigger 126 sensors is used to calculate the speed of the chip. The validation camera 130 has limited frame rate so the computed velocity of the chip is used to determine the frame with the optimal image capturing the entirety of the falling chip. That image is then analyzed by the processor of the computer board 304 to identify the denomination of the chip.

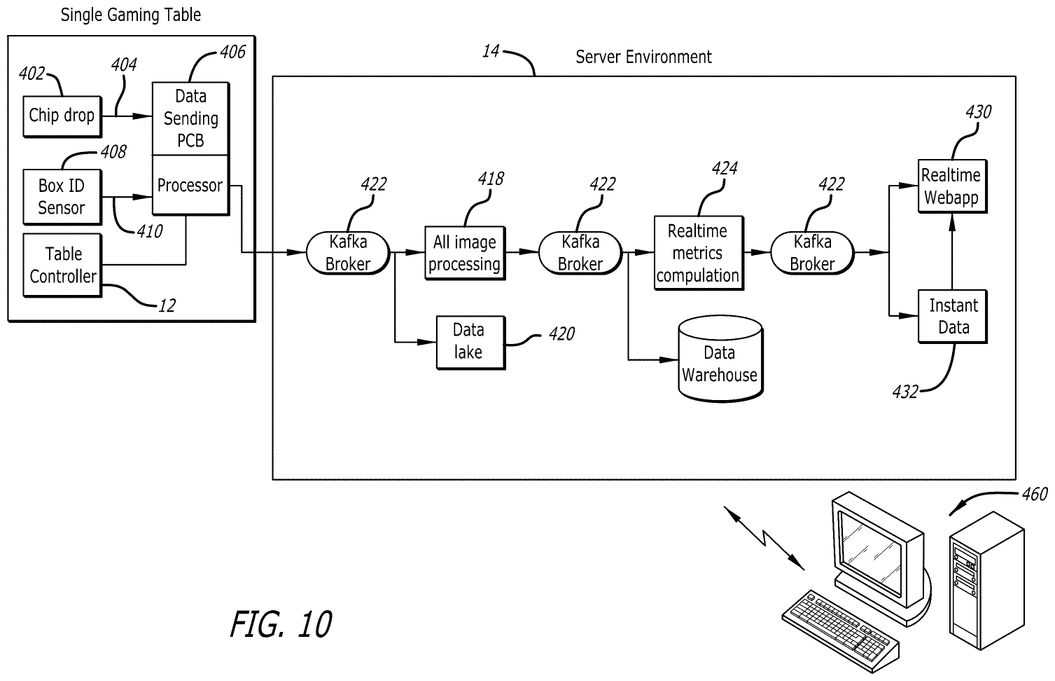

FIG. 10 depicts a typical sequence initiated when a dropped chip triggers the first light sensor optical pre-trigger 124 and initiates the validation camera 130 flash. However, the flash takes a variable amount of time to achieve full brightness for the validation camera 130 so an image cannot be captured immediately. Often, the chip is traveling too fast to allow the camera 130 to take a single picture image at the correct time when the chip is centered in the camera's view frame. Accordingly, it may be necessary for the camera 130 to take a series of image captures as fast as it can and then the processor of the computer board 304 uses the information from the triggering of the first and second light sensors to compute the speed of the falling chip and predict or extract the best camera image having the chip proximate the center of the camera's frame. The processor of the computer board 304 then analyzes the image to identify the denomination of the chip, which is generally printed in large characters in the center of the chip. Since the chip can pass through the coin slot at any rotational angle, the software of the processor of the computer board 304 must be able to recognize the denomination characters printed on the chip irrespective of the rotational orientation. The processor of the computer board 304 reports the detected and identified chip denomination to the casino server 14 (FIG. 1) via the ethernet, intranet, mesh network or hard wired communication system. In the event that the software of the processor of the computer board 304 is not able to recognize the denomination, then the processor can send the data or image of the chip through the communication system to the casino server 14 which preferably includes more powerful processing capabilities, or alternatively to a cloud based support system having enhanced artificial intelligence capabilities to recognize the chip denomination.

In an alternative embodiment for a casino or similar environment where the chip size is uniform irrespective of the denomination, a single optical transmitter such as optical pre-trigger 124 projects a beam across the center of the coin chute 110. When a chip is inserted, it breaks the optical beam so that it is not received by the optical receiver of the optical pre-trigger 124. The disruption of the optical receiver triggers a timing clock in the processor of the computer board 304 that turns off when the chip has passed through the beam from the optical transmitter of the optical pre-trigger 124 and the optical receiver is again illuminated. With the known dimension of the chip, the processor of the computer board 304 can use the timing clock on/off duration to calculate the speed of the falling chip and identify the optimal time to trigger the flash and one or more image captures by the validation camera 130, and predict or extract the best camera image having the chip proximate the center of the camera's frame as in the first embodiment.

In another embodiment, for a casino that incorporates an RFID circuit within the chips that includes information on the denomination of the chip can be ascertained by an RFID reader 450 positioned proximate the chip path through the chip validation assembly 100. The RFID reader 450 will automatically scan every chip passing through the chip validation assembly 100 and report the denomination of the chip to the processor of the computer board 304.

With any of the above embodiments, the processor of the computer board 304 associated with the chip validation assembly 100 ascertains the denomination of each chip inserted through the coin chute 110, and reports the time of receipt of the chip as well as the denomination to the casino server 14. When players initiate play at a specific gaming table, they are registered either by being assigned by the casino manager to a seat/table, or by swiping a player card at the gaming table. The real-time chip drop accounting system allows the casino to identify players that impact the speed of play at a table as well as the amount being wagered per hand. This information is useful to the casino in that it allows the casino to identify those individuals who impact the entire table in either a positive or negative way. For example, when a particular player enters a game, the player may deliberately slow down the game, and in some instances other players at the table may recognize a known professional player and as a result decrease the amount the wager or fold earlier then they would in the absence of the known player. Also, some players may be disliked by other players leave the table when the new disliked player is assigned. The casino server can use the play data from the drops to notify the casino manager to selectively place certain identified players together or move certain players to another location. The casino server can also determine the hands per hour as well as or separately from the amount wagered per hand at each table and thereby rate the dealers based on speed of play and/or amounts played.

The information provided by the real-time chip validation assembly 100 to the casino server allows the casino to decide open more tables, close tables, determine if a high or low profit/revenue player is at a table, determine if a slow-playing player is at a table, determine if a disliked player is at a table. In addition, the information provided by the real-time chip validation assembly 100 to the casino server may allow the casino to determine if a dealer is collecting the correct amount for each hand. For example, each table will have a predetermined drop for specific amounts wagered per hand. In one scenario, up to $100 in the pot generates a drop of $4, $100 to $500 generates a drop of $6 and $500 to $1000 generates a drop of $12. If a drop amount if chips not equal to one of the three predetermined drop amounts is identified by the chip validation assembly, the casino server can notify the casino manager that the dealer is not collecting the correct amount of the drop per hand. Finally, the information provided by the real-time chip validation assembly 100 to the casino server including the total number and denominations of all chips deposited into a specifically identified collection box can be reported to the count room and correlated to the amount recovered from the specifically identified collection box in the count room. It is further contemplated that the chip validation assembly 100 will be able to identify the denomination of each chip as it passes through and allow an intelligent collection box to separate and stack specific chip denominations together to expedite the operation of the count room.

FIG. 10 depicts an exemplary flow chart tracing the information from the processor of the computer board 304 at each gaming table associated with the validation assembly and collection box verification system 20. Box 402 represents the data from the chip validation assembly 100 hard wired 404 to a data sending printed circuit board (PCB) and its processor represented at box 406. Box 408 represents data sent from the collection box verification system 102 hard wired 410 to a data sending printed circuit board (PCB) and its processor represented at box 406, identifying the collection box associated with the validation assembly and collection box verification system 20. Ther table controller 12 is also preferably connected to the data sending printed circuit board (PCB) and its processor represented at box 406. The PCB or the processor preferably include a clocking circuit so that the processor can calculate the speed of the falling chip and record the exact time of the chip drop in real time to the casino server 14.

The casino server 14 receives information and data from the PCB or the processor hard wired or wirelessly as represented by line 412. The data relating to the chip denomination, the timing of the chip drop and the identification of the collection box is first reported to a first kafka broker server within the casino server 14, represented by box 416. Data from the first kafka broker server is forwarded to an artificial intelligence image processing program 418 as well as to a data lake 420. Data output from the artificial intelligence image processing program 418 is routed to a second kafka broker 422. Data from the second kafka broker is routed to real time metrics computation 424 as well as a data warehouse or memory 426. Data from the real time metrics computation 424 is routed to a third kafka broker 428, which outputs data to a real time web application 430 as well as an instant data report 432. Data from the instant data report may be forwarded to the real time web application 430, as illustrated by line 434. In addition, when the processor of the chip validation assembly 100 as well as the casino server 14 are unable to identify the denomination of a chip, coin or token, the data image may be forwarded to an external computing system 460 having enhanced artificial intelligence and processing capabilities for identifying the denomination.

The foregoing description of the present invention is intended to identify the primary components of the system, its operation and the benefits to the casino derived from the information provided by the real-time data acquisition of the rake or drop being received at each gaming table, and methods of using that information to better manage the players, dealers and casino operations. It is recognized that those skilled in the art may be able to modify or adapt the foregoing teaching to provide an alternate system and or methods. However, description is intended to be exemplary, and the proper scope and protection afforded by the of the invention is to be defined by the appended claims.

1. A chip validation assembly and collection box verification system comprising:
a chip validation assembly and a collection box verification system, both mounted on a frame, the chip validation assembly having a coin chute to project up through an opening in a gaming table and a chip validation housing made from sheet metal, plastic or composite materials; and
the chip validation housing enclosing means for identifying the denomination of chips, coins or tokens deposited through the coin chute and reporting the time and denomination of the deposit to a casino server via an ethernet, intranet, mesh network or hard wired communication system.

2. The chip validation assembly and collection box verification system of claim 1, wherein said means for identifying the denomination of chips, coins or tokens further comprises:
at least one optical trigger;
a camera electrically coupled to and activated by said optical trigger initiated by the passage of a chip, coin or token through said optical trigger;
a processor receiving images captured by said camera; and
a program in said processor to identify the denomination of the chip, coin or token captured in an image by said camera.

3. The chip validation assembly and collection box verification system of claim 1, wherein said means for identifying the denomination of chips, coins or tokens further comprises an RFID reader positioned proximate said coin chute to read an RFID identifier within a chip or token.

4. The chip validation assembly and collection box verification system of claim 1, wherein said means for identifying the denomination of chips, coins or tokens further comprises: an optical code reader capable of reading a bar code or QR code printed on a chip or token passing through said chip validation assembly.

5. The chip validation assembly and collection box verification system of claim 1, wherein said collection box verification system further comprises:
at least one optical trigger initiated by the passage of a chip, coin or token;
a collection box camera positioned within said collection box verification system oppositely disposed to a collection box identifier, said camera triggered by said optical trigger upon the deposit of a chip, coin or token; and
a processor coupled to receive images from said collection box camera to read the collection box identifier and report the identifier to said casino server.

6. The chip validation assembly and collection box verification system of claim 2, wherein said at least one optical trigger further comprises:
an optical pre-trigger including an optical emitter and an optical receiver oppositely disposed across said coin chute; and
an optical trigger including an optical emitter and an optical receiver oppositely disposed within said chip validation assembly to initiate said camera.

7. The chip validation assembly and collection box verification system of claim 2, wherein said processor further includes a clock function to time the duration of passage of a chip, coin or token passing through said chip validation assembly to determine the speed of the chip, coin or token and the time of deposit of the chip, coin or token.

8. The chip validation assembly and collection box verification system of claim 5, wherein said processor coupled to receive images from said collection box camera to read the collection box identifier selected from the group consisting of a numerical identifier, a bar code, a QR code, or alternative unique paint splashes, colors, etchings, scratches or surface texturing, or a combination thereof.

9. The chip validation assembly and collection box verification system of claim 1, further comprising:
a table controller including a computer board, an expansion board and a cover, said expansion board including one or more of USB ports, an ethernet port and an audio jack, said computer board including circuitry connecting the respective components of said chip validation assembly and collection box verification system to a processor on said computer board and therethrough to said casino server capable of identifying the denomination of an imaged chip provided by said chip validation assembly.

10. A casino operations management system comprising:
a casino server having a casino management program;
a plurality of gaming tables, each gaming table having a collection box for receiving revenue for the casino;
an ethernet, internet, mesh network or hard wired communication system linking said casino server to at least one processor positioned at each of said gaming tables; and
a chip validation assembly and a collection box verification system positioned at each of said gaming tables proximate said collection box, said chip validation housing enclosing means for imaging chip and identifying the denomination of chips, coins or tokens deposited through said chip validation assembly to said collection box without stopping the passage of the chip, coin or token, and reporting the time, image or denomination of the deposited chip to said casino server via said ethernet, intranet, mesh network or hard wired communication system.

11. The casino operations management system of claim 10 further comprising:
at least one optical trigger initiated by the passage of a chip, coin or token;
a collection box camera positioned within said collection box verification system oppositely disposed to a collection box identifier, said camera triggered by said optical trigger upon the deposit of a chip, coin or token; and
a processor coupled to receive images from said collection box camera to read the collection box identifier and report the identifier to said casino server.

12. The casino operations management system of claim 10 wherein said means for identifying the denomination of chips, coins or tokens further comprises:
at least one optical trigger;
a camera electrically coupled to and activated by said optical trigger initiated by the passage of a chip, coin or token through said optical trigger;
a processor receiving images captured by said camera; and
a program in said processor to identify the denomination of the chip, coin or token captured in an image by said camera.

13. The casino operations management system of claim 10, wherein said collection box verification system further comprises:
at least one optical trigger initiated by the passage of a chip, coin or token;
a collection box camera positioned within said collection box verification system oppositely disposed to a collection box identifier, said camera triggered by said optical trigger upon the deposit of a chip, coin or token; and
a processor coupled to receive images from said collection box camera to read the collection box identifier and report the identifier to said casino server.

14. A method for managing casino operations comprising:
providing a casino server having a casino management program;
providing a plurality of gaming tables, each gaming table having a collection box for receiving revenue for the casino;
providing an ethernet, internet, mesh network or hard wired communication system linking said casino server to at least one processor positioned at each of said gaming tables;
providing a chip validation assembly positioned at each of said gaming tables proximate said collection box, said chip validation housing enclosing means for identifying the denomination of chips, coins or tokens deposited therethrough to said collection box without stopping the passage of the chip, coin or token, and reporting the time and denomination of the deposit to said casino server via said ethernet, intranet or hard wired communication system;
using the real-time reporting of the collection of chips, coins or tokens to identify the amount being wagered per hand.

15. The method for managing casino operations of claim 14, further comprising:
using the real-time reporting of the collection of chips, coins or tokens to identify players that impact the play at a table.

16. The method for managing casino operations of claim 14, further comprising:
using the real-time reporting of the collection of chips, coins or tokens to determine the hands per hour, the amount wagered per hand at each table or rate the dealers based on speed of play and amounts played.

17. The method for managing casino operations of claim 14, further comprising:
using the real-time reporting of the collection of chips, coins or tokens to determine if a dealer is collecting the correct amount for each hand.

18. The method for managing casino operations of claim 14, further comprising:
using the real-time reporting of the collection of chips, coins or tokens to determine whether to open more tables, close tables, identify a high or low profit/revenue player is at a table, identify a slow-playing player at a table, or identify a disliked player is at a table.

19. The method for managing casino operations of claim 14, further comprising:
providing a collection box verification system positioned at each of said gaming tables proximate said collection box, said collection box verification system comprises:
at least one optical trigger initiated by the passage of a chip, coin or token;
a collection box camera positioned within said collection box verification system oppositely disposed to a collection box identifier, said camera triggered by said optical trigger upon the deposit of a chip, coin or token; and
a processor coupled to receive images from said collection box camera to read the collection box identifier and report the identifier to said casino server.
